(19) United States
(12) Patent Application Publication
(10) Pub. No.: US 2015/0340802 A1
(43) Pub. Date: Nov. 26, 2015

(54) Plug Connector

(71) Applicant: SICK AG, Waldkirch (DE)

(72) Inventors: Torsten NEUHAUSER, Bahlingen (DE); Frank GUTMANN, Freiburg (DE); Olaf MACHUL, Merzhausen (DE)

(21) Appl. No.: 14/716,042

(22) Filed: May 19, 2015

(30) Foreign Application Priority Data
May 20, 2014 (EP) 14168960.4

(51) Int. Cl. H01R 13/52

(52) U.S. Cl. CPC H01R 13/5219

(57) ABSTRACT

A plug connector for a single-core or multi-core electrical line comprises a plug which comprises a plug body having an end face and at least one connector pin projecting from the end face; a coupling which comprises a coupling body having an end face, wherein at least one reception opening is arranged in the end face of the coupling body for plugging in the at least one connector pin of the plug for establishing a connection; an actuable closure for holding the plug body at the coupling body with a connector pin plugged into the reception opening; and at least one sealing element composed of an elastically deformable material for sealing the connection between the plug and the coupling. The at least one sealing element is clamped between the end face of the plug body and the end face of the coupling body while being deformed when the closure holds the plug body at the coupling body.

The present invention relates to a plug connector for a single-core or multi-core electrical line, comprising a plug which comprises a plug body having an end face and at least one connector pin projecting from the end face; a coupling which comprises a coupling body having an end face, wherein at least one reception opening is arranged in the end face of the coupling body for plugging in the at least one connector pin of the plug for establishing a connection; an actuable closure for holding the plug body at the coupling body with a connector pin plugged into the reception opening; and at least one sealing element composed of an elastically deformable material for sealing the connection between the plug and the coupling.

Such plug connectors are used, for example, for connecting actuators and sensors to safety controls. The plug can in this respect in particular be configured as a panel plug which is integrated into the sensor housing or actuator housing. An unintended disconnection of the plug connector during the operation of the associated device is avoided due to the closure. It is in particular important in the environment of industrial plant to protect the plug connection from contamination and from a penetration of moisture.

This typically takes place by a sealing element in the form of an O ring which is arranged in a closure sleeve at the coupling side and which is pressed against the sleeve base by a closure sleeve at the plug side introduced into the closure sleeve at the coupling side with a closed closure. The sealing surface in this embodiment is, however, relatively narrow so that the sealing effect is frequently insufficient in practice. In addition, the O ring may be damaged due to the narrow sealing surface, in particular on a frequent connection and disconnection of the plug connector.

It is an object of the invention to allow a more reliable sealing of plug connectors with simple means.

The object is satisfied by a plug connector having the features of claim 1.

In accordance with the invention, the at least one sealing element is clamped between the end face of the plug body and the end face of the coupling body while being deformed when the closure holds the plug body at the coupling body. The sealing therefore takes place directly between the plug body and the coupling body. This is advantageous in that the sealing surface is enlarged with respect to an outer sealing by means of an O ring. In addition, the clamping force effective in the region of the—generally planar—end faces is uniformly distributed so that damage to the sealing element is avoided. The proneness of the seal with respect to component tolerances can also be reduced since the end faces of the plug body and of the coupling body also abut one another with components subject to tolerances. The sealing of a plug connector of the named kind can thus be substantially improved by the arrangement of the sealing element between these end faces. A further advantage is an increased stability with respect to electrostatic discharge (ESD).

As a rule, such plug connectors have a plurality of connector pins (e.g. three or more) in the plug and a corresponding number of reception openings in the coupling, with a particularly good adjustment of the sealing element then advantageously being produced. The invention can, however, generally also be used in designs having only one connector pin and one reception opening.

An embodiment of the invention provides that the sealing element does not project beyond the margin of the end face of the plug body and/or beyond the margin of the end face of the coupling body in a radial direction with respect to the longitudinal axis of the at least one connector pin. The sealing element in this configuration is therefore arranged completely between the two end faces. This makes possible a uniform distribution of the clamping force and thus a reduction of the mechanical load on the sealing element. In addition, no construction space for the sealing element has to be provided in the radial environment region of the plug body and of the coupling body.

The sealing element can be fastened to the end face of the coupling body. It is, however, preferred to fasten the sealing element to the end face of the plug body—to the so-called plug base—since in this case friction locking between the connector pin and a leadthrough of the sealing element provided for the connector pin can provide a correct fit of the sealing element. If necessary, the sealing element can be adhesively bonded to the end face of the plug body.

A further embodiment of the invention provides that the closure has a closure sleeve at the plug side which is provided at the plug body and which is configured to laterally engage around of the coupling body, with the sealing element being arranged in a coupling receiver which is formed by the end face of the plug body and by an inner wall of the closure sleeve at the plug side. Such closures are used, e.g. in the form of screw closures, in many plug connectors to ensure a secure fit of the plug body at the coupling body. As mentioned above, an O ring is frequently positioned as a sealing element at the base of the closure sleeve at the coupling side with such plug connectors so that, on the closing of the closure, the front margin of the closure sleeve at the plug side screwed into the closure sleeve at the coupling side is pressed against the O ring. The sealing effect in this configuration depends on the torque with which the two closure sleeves are screwed tight to one another. If the torque is too low, the O ring will not be clamped sufficiently so that dirt and moisture can penetrate into the plug connector. If the torque is too high, the O-ring will in contrast be damaged, whereby in turn a reduction of the sealing effect occurs. The shear forces exerted on the O ring in the course of the screwing of the closure sleeves represent a particular problem in this respect. In addition, it frequently occurs in practice due to component tolerances that the end face of the plug body and the end face of the coupling body already abut one another before the O ring is compressed to a sufficient degree between the closure sleeves. There is also not a sufficient sealing effect in this case. With the arrangement in accordance with the invention of the sealing element between the end faces of the plug body and of the coupling body, the above-named problems can also be avoided in embodiments with a closure sleeve provided at the plug body and engaging around the coupling body. No shear forces are exerted on the sealing element arranged in accordance with the invention, in particular because the end faces of the plug body and of the coupling body do not rotate with respect to one another during the screwing of the closure sleeves. The sealing element preferably completely covers the base of the coupling receiver.

The closure can specifically have a closure sleeve at the plug side provided at the plug body and a closure sleeve at the coupling side provided at the coupling body, the closure sleeves being able to be screwed to one another. The sealing element can thus be integrated into the plug in a simple manner. Alternatively or additionally, the closure sleeve at the plug side and the closure sleeve at the coupling side can also be latched to one another.

In accordance with a further embodiment of the invention, the sealing element comprises a base body which is configured as a flat plate or disk and whose one flat side contacts the end face of the plug body and whose other flat side is configured to lie at the end face of the coupling body, or vice versa, with the base body having at least one leadthrough for leading through the at least one connector pin. Such a flat base body provides a large sealing surface. Depending on the application, a flat side of the base body can contact the plug body or the coupling body, for example, can be fastened thereto, while the other flat side is exposed and only contacts the end face of the respective other component in the connected state of the plug and coupling.

The at least one connector pin can be seated without clearance in the leadthrough. A particularly secure sealing effect can thereby be achieved. In addition, there is the possibility that the sealing element is only held at the plug body via friction locking between the connector pin and the inner wall of the leadthrough.

In accordance with a further embodiment of the invention, at least two mutually spaced apart connector pins project from the end face of the plug body and can be plugged into respective reception openings of the end face of the coupling body, with a ring-shaped buffer element of an elastically deformable material extending around each of the connector pins. Such buffer elements e.g. provide a tolerance compensation as required.

There is preferably a free space between a respective two of the buffer elements into which material can escape on a required tolerance compensation. If required, respective free spaces can also be present between the outer surfaces of the connector pins and the inner surfaces of the associated ring-shaped buffer elements.

A specific embodiment of the invention provides that the ring-shaped buffer elements are attached to a plate-like or disk-like base body of the sealing element. The handling of the sealing element in the manufacture of the plug connector is thereby facilitated.

An alternative embodiment provides that the buffer elements themselves form sealing elements and that with the exception of the buffer elements no further sealing elements are provided between the end face of the plug body and the end face of the coupling body. The provision of such separate sealing rings at the individual connector pins can ensure a sufficient sealing effect in specific applications.

The at least one sealing element is preferably manufactured from a soft plastic, silicone and/or an elastomer. Such sealing materials are inexpensive and easy to use.

The at least one sealing element can also be manufactured from a hardenable, in particular silicone-based, polyurethane-based or epoxy-based sealing compound. A high sealing effect can hereby be achieved.

A specific embodiment provides that the at least one sealing element is configured as an injection molded part, in particular as a multi-component injection molded part. An injection molding construction is advantageous from a technical production aspect. The sealing effect and the mechanical stability of the sealing element can be optimized by a combination of different materials within the framework of the multi-component injection molding such as 2K injection molding.

The at least one sealing element can be injected directly at the end face of the plug body or at the end face of the coupling body. This allows a particularly fast and simple manufacture.

The invention also relates to a plug for use in a plug connector for a single-core or multi-core electrical line, wherein the plug connector comprises a plug body having an end face and at least one connector pin projecting from the end face; a coupling which comprises a coupling body having an end face, wherein at least one reception opening is arranged in the end face of the coupling body for plugging in the at least one connector pin of the plug for establishing a connection; an actuable closure for holding the plug body at the coupling body with a connector pin plugged into the reception opening; and has at least one sealing element composed of an elastically deformable material for sealing the connection between the plug and the coupling.

Provision is in this respect made with a plug in accordance with the invention that the at least one sealing element is arranged at the end face of the plug body.

The invention further relates to a coupling for use in a plug connector for a single-core or multi-core line, comprising a plug, wherein the plug connector comprises a plug body having an end face and at least one connector pin; a coupling which comprises a coupling body having an end face, wherein at least one reception opening is arranged in the end face of the coupling body for plugging in the at least one connector pin of the plug for establishing a connection; an actuable closure for holding the plug body at the coupling body with a connector pin plugged into the reception opening; and at least one sealing element composed of an elastically deformable material for sealing the connection between the plug and the coupling.

Provision is in this respect made with a coupling in accordance with the invention that the at least one sealing element is arranged at the end face of the coupling body.

Further developments of the invention are also set forth in the dependent claims, in the description and in the enclosed drawings.

The invention will be described in the following by way of example with reference to the drawings.

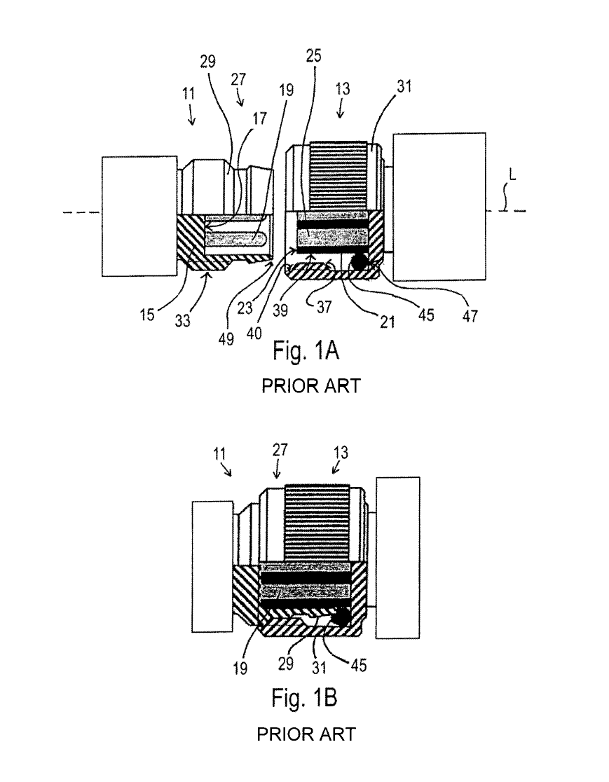

FIG. 1A shows a plug connector designed in accordance with the prior art with a plug and a coupling in a disconnected state in a partly cut-away representation;

FIG. 1B shows the plug connector in accordance with FIG. 1A, with the plug being plugged into the coupling;

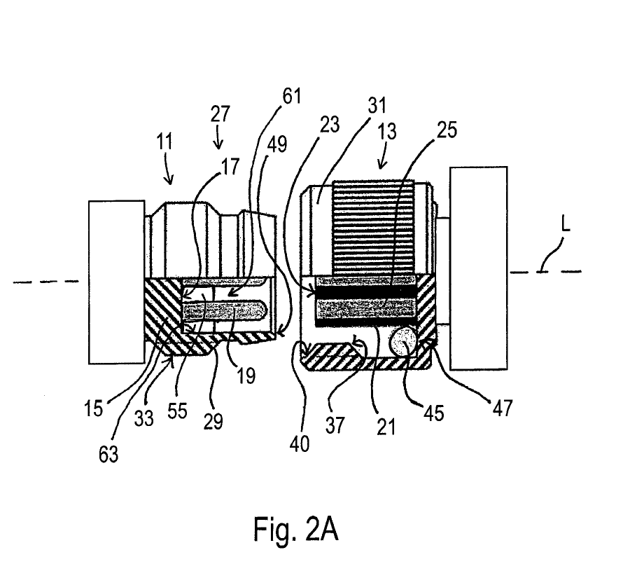

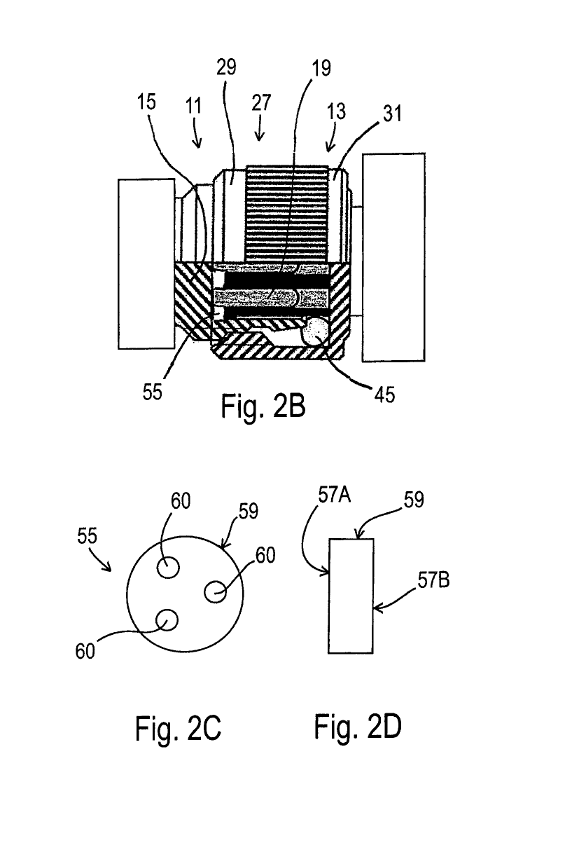

FIG. 2A shows a plug connector in accordance with a first embodiment of the invention with a plug and a coupling in the disconnected state;

FIG. 2B shows the plug connector in accordance with FIG. 2A, with the plug being plugged into the coupling;

FIG. 2C shows a sealing element of the plug connector shown in FIG. 2A in a plan view;

FIG. 2D shows the sealing element in accordance with FIG. 2C in a side view;

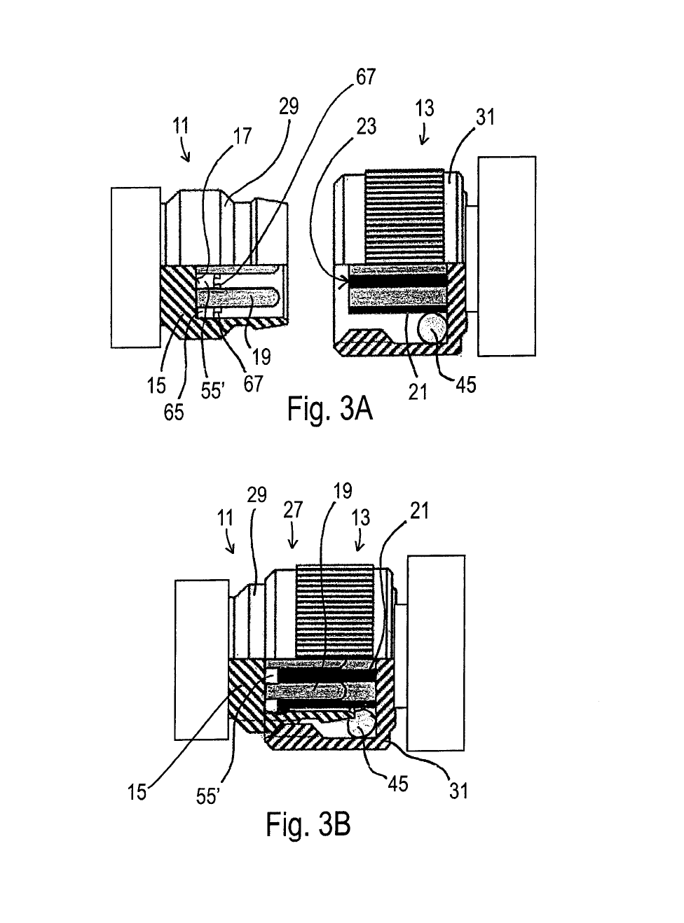

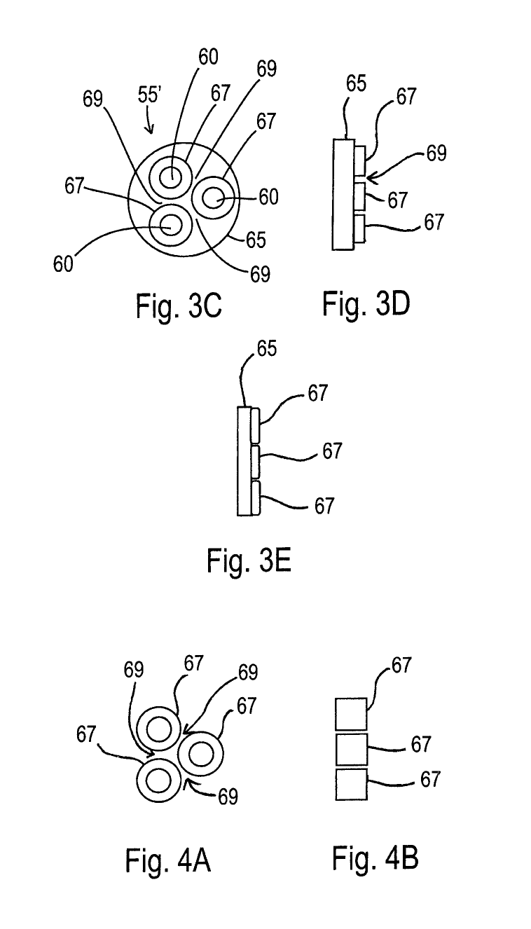

FIG. 3A shows a plug connector in accordance with a second embodiment of the invention with a plug and a coupling in the disconnected state;

FIG. 3B shows the plug connector in accordance with FIG. 3A, with the plug being plugged into the coupling;

FIG. 3C shows a sealing element of the plug connector shown in FIG. 3A in a plan view;

FIG. 3D shows the sealing element in accordance with FIG. 3C in a side view;

FIG. 3E shows the sealing element shown in FIG. 3D in a compressed state:

FIG. 4A shows an arrangement of three sealing elements for a plug connector in accordance with a third embodiment of the invention; and

FIG. 4B shows the sealing elements shown in FIG. 4A in a side view.

The plug connector shown in FIGS. 1A and 1B, designed in accordance with the prior art, serves for the selective connection and disconnection of an electrical line, a multi-core electrical line here, and comprises a plug 11 and a coupling 13. The plug 11 can be configured as a panel plug and can e.g. be integrated into a sensor housing. The coupling 13 can accordingly be located at an end of a connector cable for the corresponding sensor. The plug 11 comprises a plug body 15 having a planar end face 17 and three connector pins 19 projecting from the end face 17.

The coupling 13 comprises a coupling body 21 having an end face 23—likewise planar here—in which three reception openings 25 are arranged for plugging in the connector pins 19 of the plug 11. To establish the electrical connection, the plug 11 and the coupling 13 are plugged together while introducing the connector pins 19 into the reception openings 25. It is understood that the number, the arrangement and the shape of the connector pins 19 may vary in dependence on the application.

To secure the connection, a closure 27 is provided which is here configured as a screw closure and comprises a closure sleeve 29 at the plug side and a closure sleeve 31 at the coupling side. The closure sleeve 29 at the plug side has an external thread 33 and is rotationally-fixedly fastened to the plug body 15. The closure sleeve 29 at the plug side is furthermore configured to laterally engage around the coupling body 21, e.g. a cylindrical coupling body. The closure sleeve 31 at the coupling side has an internal thread 37 and is supported at the coupling body 21 rotatable about a longitudinal axis L of the electrical line. A sealing element 45 in the form of an O ring which is produced from an elastically deformable material is located between an outer wall 39 of the coupling body 21 and an inner wall 40 of the closure sleeve 31 at the coupling side. As shown, the sealing element 45 contacts a base 47 of the closure sleeve 31 at the coupling side.

When plugging together the plug 11 and the coupling 13, the closure sleeve 29 at the plug side moves into the closure sleeve 31 at the coupling side. The closure sleeve 31 at the coupling side is then screwed onto the closure sleeve 29 at the plug side until the connection state shown in FIG. 1B is achieved. The connector pins 19 in this connection state engage in a contacting manner into the reception openings 25. The front border 49 of the closure sleeve 29 at the plug side furthermore presses in the connection state against the sealing element 45 so that it is clamped between the closure sleeve 29 at the plug side and the closure sleeve 31 at the coupling side. It can be seen from FIG. 1B that the clamping surface is only relatively small and the sealing element 45 is moreover unevenly loaded. Furthermore, comparatively strong shear forces are exerted onto the sealing element 45 on the screwing together of the closure sleeves 29, 31.

In the first embodiment of the invention shown in FIGS. 2A to 2D, these problems are eliminated in that a sealing element 55 in the form of a flat disk is arranged at the end face 17 of the plug body 15. As can be seen from the individual representations in accordance with FIGS. 2C and 2D, the sealing element 55 is circular and has two flat sides 57A, 57B as well as a peripheral narrow side 59. Three leadthroughs 60 serve for leading through the connector pins 19 and are adapted to them with respect to their diameters. The sealing element 55 can be manufactured from a soft plastic, silicone and/or from an elastomer. As can be recognized in FIG. 2A, the sealing element 55 is arranged in a coupling receiver 61 which is formed by the end face 17 of the plug body 15 and by an inner wall 63 of the closure sleeve 29 at the plug side. An O ring is arranged at the base 47 of the closure sleeve 31 at the coupling side as an additional sealing element 45, as with the above-described conventional plug connector, with this, however, not being compulsory.

When plugging together the plug 11 and the coupling 13, the sealing element 55 is clamped between the end face 17 of the plug body 15 and the end face 23 of the coupling body 21 and is thereby uniformly compressed. A secure sealing of the connection is thereby ensured—and indeed independently of the torque with which the closure sleeve 31 at the coupling side is screwed onto the closure sleeve 29 at the plug side. Since only axial forces act on the sealing element 55 and these are moreover distributed over a comparatively large surface, damage to the sealing element 55 is hardly to be expected. This in particular applies since no shear forces are exerted onto the sealing element 55. The end face 17 of the plug body 15 and the end face 23 of the coupling body 21 namely remain in their non-rotated starting state during the screw procedure.

The plug connector shown in FIGS. 3A to 3E and designed in accordance with a second embodiment of the invention has a similar design to the plug connector described above in connection with FIGS. 2A to 2D, with components having the same effect being designated by the same reference numerals. The sealing element 55′, however, here has a disk-shaped base body 65 and additionally three ring-shaped buffer elements 67 which are fastened to the base body 65 and which extend around the leadthroughs 60. The ring-shaped buffer elements 67 are spaced apart from one another so that free spaces 69 are present between all buffer elements 67. On a pressing together of the buffer elements 67, they can escape radially outwards due to the free spaces 69, as is shown in FIG. 3E. A tolerance compensation is thereby possible.

The ring-shaped buffer elements 67 can be fastened to the base body 65 or can be placed onto the connection pins 19 only after the fastening of the base body 65 to the plug body 15. In specific applications, it can also be sufficient only to use the ring-shaped buffer elements 67 as sealing elements. Such an embodiment is shown in FIGS. 4A and 4B.

The sealing elements 55, 55′, 67 are shown as independent components in FIGS. 2C, 2D, 3C-3E and 4A and 4B. It is, however, also possible if required to mold or inject such sealing elements 55, 55′, 67 directly to the end face 17 of the plug body 15 or also to the end face 23 of the coupling body 21.

The seal in accordance with the invention can in principle be used for any desired construction shape of plug connectors. Not only the sealing effect is improved by the sealing material present all around the connector pins 19, but also the stability with respect to electrostatic discharge (ESD). In principle, sealing elements such as are shown in FIGS. 2A-2D, 3A-3E, 4A and 4B can also be arranged at the end face 23 of the coupling body 21. An arrangement at the plug base, however, has the advantage of a more favorable accommodation. The invention in particular allows a particularly reliable sealing of plug connections overall also with comparatively large component tolerances.

### REFERENCE NUMERAL LIST

11 plug
13 coupling
15 plug body
17 end face
19 connector pin
21 coupling body
23 end face
25 reception opening
27 closure
29 closure sleeve at the plug side
31 closure sleeve at the coupling side
33 external thread
37 internal thread
39 outer wall
40 inner wall
45 sealing element
47 base
49 border
55, 55′ sealing element
57A flat side
57B flat side
59 narrow side
60 leadthrough
61 coupling receiver
63 inner wall
65 base body
67 ring-shaped buffer element
69 free space
L longitudinal axis

1. A plug connector for a single-core or multi-core electrical line, comprising:
a plug which comprises a plug body having an end face and at least one connector pin projecting from the end face;
a coupling which comprises a coupling body having an end face, wherein at least one reception opening is arranged in the end face of the coupling body for plugging in the at least one connector pin of the plug for establishing a connection;
an actuable closure for holding the plug body at the coupling body with a connector pin plugged into the reception opening; and
at least one sealing element composed of an elastically deformable material for sealing the connection between the plug and the coupling,
wherein the at least one sealing element is clamped between the end face of the plug body and the end face of the coupling body while deforming when the closure holds the plug body at the coupling body.

2. The plug connector in accordance with claim 1, wherein sealing element does not project beyond the margin of the end face of the plug body and/or beyond the margin of the end face of the coupling body in a radial direction with respect to the longitudinal axis of the at least one connector pin.

3. The plug connector in accordance with claim 1, wherein the sealing element is fastened to the end face of the plug body.

4. The plug connector in accordance with claim 1, wherein the closure has a closure sleeve at the plug side which is provided at the plug body and which is configured to laterally engage about the coupling body, wherein the sealing element is arranged in a coupling receiver which is formed by the end face of the plug body and by an inner wall of the closure sleeve at the plug side.

5. The plug connector in accordance with claim 1, wherein the closure has a closure sleeve at the plug side which is provided at the plug body and a closure sleeve at the coupling side which is provided at the coupling body, said closure sleeves being able to be screwed to one another.

6. The plug connector in accordance with claim 1, wherein the sealing element comprises a base body which is configured as a flat plate or as a disk, whose one flat side contacts the end face of the plug body and whose other flat side is configured for lying at the end face of the coupling body, or vice versa, wherein the base body has at least one leadthrough for leading through the at least one connector pin.

7. The plug connector in accordance with claim 6, wherein the at least one connector pin is seated without clearance in the leadthrough.

8. The plug connector in accordance with claim 1, wherein at least two mutually spaced apart connector pins project from the end face of the plug body and can be plugged into respective reception openings of the end face of the coupling body, wherein a ring-shaped buffer element composed of an elastically deformable material extends around each of the connector pins.

9. The plug connector in accordance with claim 8, wherein there is a respective free space between two of the buffer element.

10. The plug connector in accordance with claim 8, wherein the ring-shaped buffer elements are attached to a plate-like or disk-like base body of the sealing element.

11. The plug connector in accordance with claim 8, wherein the buffer elements themselves form sealing elements and, with the exception of the buffer element, no further sealing elements are provided between the end face of the plug body and the end face of the coupling body.

12. The plug connector in accordance with claim 1, wherein the at least one sealing element is manufactured from a soft plastic, silicone and/or an elastomer.

13. The plug connector in accordance with claim 1, wherein the at least one sealing element is manufactured from a hardenable sealing compound.

14. The plug connector in accordance with claim 1, wherein the at least one sealing element is configured as an injection molded component.

15. The plug connector in accordance with claim 14, wherein the at least one sealing element is injected directly at the end face of the plug body or at the end face of the coupling body.

16. A plug for use in a plug connector, the plug connector comprising:
a plug which comprises a plug body having an end face and at least one connector pin projecting from the end face;
a coupling which comprises a coupling body having an end face, wherein at least one reception opening is arranged in the end face of the coupling body for plugging in the at least one connector pin of the plug for establishing a connection;
an actuable closure for holding the plug body at the coupling body with a connector pin plugged into the reception opening; and
at least one sealing element composed of an elastically deformable material for sealing the connection between the plug and the coupling, wherein the at least one sealing element is clamped between the end face of the plug body and the end face of the coupling body while deforming when the closure holds the plug body at the coupling body;
wherein the at least one sealing element is arranged at the end face of the plug body.

17. A coupling for use in a plug connector, the plug connector comprising:
a plug which comprises a plug body having an end face and at least one connector pin projecting from the end face;
a coupling which comprises a coupling body having an end face, wherein at least one reception opening is arranged in the end face of the coupling body for plugging in the at least one connector pin of the plug for establishing a connection;
an actuable closure for holding the plug body at the coupling body with a connector pin plugged into the reception opening; and
at least one sealing element composed of an elastically deformable material for sealing the connection between the plug and the coupling, wherein the at least one sealing element is clamped between the end face of the plug body and the end face of the coupling body while deforming when the closure holds the plug body at the coupling body;
wherein the at least one sealing element is arranged at the end face of the coupling body.
